(19) United States
(12) Patent Application Publication
(10) Pub. No.: US 2007/0053151 A1
(43) Pub. Date: Mar. 8, 2007

(54) Display mounting system

(76) Inventors: Richard Capoferri, Newtown Square, PA (US); Frank V. Linker JR., Broomall, PA (US)

Correspondence Address: Eugene E. Renz, Jr., P.C., 205 North Monroe Street, Post Office Box 2056, Media, PA, 19063-9056, US

(21) Appl. No.: 11/501,501

(22) Filed: Aug. 8, 2006

Related U.S. Application Data
(60) Provisional application No. 60/707,499, filed on Aug. 11, 2005.

(51) Int. Cl. G06F 1/16

(52) U.S. Cl. 361/686

(57) ABSTRACT

A wall mounted display system is described. The display system comprises an extendable articulating arm assembly mounted into an enclosure that mounts between two wall studs. The mechanics of the arm assembly is such that the display monitor moves parallel to the wall as the arm is being extended. Once the arm is extended to the desired position, the monitor angle may be adjusted in both the vertical and horizontal dimensions, to allow an optimal viewing angle to be achieved. A remote control receiver allows a user to control the display mounting system with a remote control, eliminating the need to actually touch the display monitor.

### FIELD OF THE INVENTION

The present invention relates to a mounting system for a display. More specifically, the present invention relates to a mounting system suitable for wall mounting a relatively thin display monitor, such as an LCD or plasma monitor.

### BACKGROUND

As technology develops, the cost of various “flat panel” technologies has dropped, resulting in increased popularity of thin “flat panel” display monitors. These display monitor types include LCD, plasma, and DLP, among others. Regardless of the technology used, flat panel display monitors are becoming more affordable and more popular for home use.

Modern flat panel monitors, in addition to being much thinner than conventional CRT televisions, are also commonly found in the widescreen (16:9) format. The different dimensions of the flat panel monitor offer different possibilities for the location of the display unit within a home. For example, due to the widescreen format, the flat panel monitor may not fit well within the space allotted in a conventional entertainment center. Furthermore, due to the reduced depth, many users desire to mount the flat panel display to the wall, both for space saving reasons, as well as for decor purposes.

It is usually preferable to view the flat panel monitor at the most direct angle possible. While there is variation among the different display technologies, in some cases, the picture is substantially less viewable when viewed at an angle.

It may be desirable to mount the display monitor above eye level, such that the display monitor is out of reach of children. Furthermore, depending on what part of the room is in use may affect the optimal angle for the display monitor. It is also desirable to have the monitor affixed to the wall as close as possible when not in use, for both safety and decor purposes. Furthermore, many users, especially those with sophisticated “home theater” systems, desire a display mounting system with automation capabilities. Therefore, there exists a need for a display mounting system that can address the aforementioned issues presented by the advent of flat panel technology.

### SUMMARY OF THE INVENTION

The present invention provides a wall mounted display system that is well suited for flat panel display monitors. In a preferred embodiment, the display system comprises an extendable articulating arm assembly mounted into an enclosure that mounts between two wall studs. The mechanics of the arm assembly is such that the display monitor moves parallel to the wall as the arm is being extended. Once the arm is extended to the desired position, the monitor angle may be adjusted in both the vertical and horizontal dimensions, to allow an optimal viewing angle to be achieved. A remote control receiver allows a user to control the display mounting system with a remote control, eliminating the need to actually touch the display monitor.

### ASPECTS OF THE INVENTION

In a first aspect of the invention, the invention provides a display mounting system that mounts a display monitor onto a wall, and extends the display monitor a predetermined distance from the wall, keeping the display monitor parallel to the wall as the monitor is being extended from the wall.

In a second aspect of the invention, the invention provides a means for a horizontal viewing angle adjustment, allowing panning of the display monitor.

In a third aspect of the invention, the invention provides a means for a vertical viewing angle adjustment, allowing tilting of the display monitor.

In a fourth aspect of the invention, the invention provides an extendable articulating arm assembly that moves the display monitor to and from the wall.

In a fifth aspect of the invention, the invention of the fourth aspect further comprises a microprocessor that controls the motors of the extendable articulating arm assembly.

In a sixth aspect of the invention, the invention provides a remote control means, whereby a user may control the position of the display monitor via a remote control.

In a seventh aspect of the invention, the remote control means of the invention of the sixth aspect is infrared.

In an eighth aspect of the invention, the remote control means of the invention of the sixth aspect is radio frequency.

In a ninth aspect of the invention, extendable articulating arm assembly of the fourth aspect further comprises a first large gear on a lower arm, said first large gear driving a first small gear on the distal end of said lower arm via a first chain, said small gear turning an upper arm, said upper arm having second small gear, said second small gear driving a second large gear on the distal end of said upper arm, whereby the ratio of a large gear to a small gear is two to one, whereby the motorized extension mechanism maintains the display monitor in an orientation parallel to the wall it is mounted to as it travels to and from the wall.

In a tenth aspect, the invention of the fifth aspect further provides a means for storing and retrieving at least one position, thereby allowing a user to save at least one favorite position, and return the display monitor to that position with a convenient action such as a button press.

In an eleventh aspect of the invention, the invention of the fourth aspect further comprises a plurality of limit switches on the extendable articulating arm assembly to determine when the maximum travel position has been reached.

In a twelfth aspect of the invention, the invention of the fourth aspect further comprises a at least one encoder to provide intermediate positioning information of the extendable articulating arm assembly, thereby allowing a partially extended position to be saved as a favorite.

The present invention provides a display system comprising:

a first arm, having a first and second end, the first arm having a large gear at the first end and a small gear at the second end and a transmission means between the large gear of the first arm and the small gear of the first arm, with the first end rotatably mounted within an enclosure;

a second arm, having a first and second end, the second arm having a small gear at the first end and a large gear at the second end and a transmission means between the large gear of the second arm and the small gear of the second arm, wherein the small gear of the first arm is the same size as the small gear of the second arm, and the large gear of the first arm is the same size as the large gear of the second arm, and the first end of the second arm is rotatably connected to the second end of the first arm via a shaft that has the small gear of the first arm and the small gear of the second arm axially collocated thereon, wherein the second end of the second arm is rotatably connected to a mounting bracket;

motive means that is mechanically connected to the small gears and large gears of the first and second arms via mechanical linkage; and

wherein the ratio of a large gear to a small gear is two to one, thereby maintaining the mounting bracket in an orientation parallel to the enclosure it is mounted to as it travels to and from the enclosure.

In one embodiment of the present invention, the transmission means between the large gear of the first arm and the small gear of the first arm is a chain, and the transmission means between the large gear of the second arm and the small gear of the second arm is a chain.

In another embodiment of the present invention, the transmission means between the large gear of the first arm and the small gear of the first arm is a belt, and the transmission means between the large gear of the second arm and the small gear of the second arm is a belt.

In another embodiment of the present invention, the motive means is an electric motor.

In another embodiment of the present invention, the display system further comprises a microprocessor that interfaces with a remote command receiver. The remote command receiver has means for receiving remote control commands from a user. The microprocessor also controls the motive means (e.g. motors) thereby allowing the user to control the display system via a remote control.

In another embodiment of the present invention, the display system further comprises a pivot motor that is mechanically linked to small gear of the second arm. This allows the horizontal angle of the mounting bracket with respect to the enclosure to be adjustable via said pivot motor.

In another embodiment of the present invention, the display system further comprises tracking means for tracking the current position of the first and second arms.

In another embodiment of the present invention, the tracking means is comprised of at least one encoder.

In another embodiment of the present invention, the display system further comprises feature of storing the current position of the first and second arms in memory as a favorite position.

In another embodiment of the present invention, the display system further comprises feature of retrieving the position of the first and second arms from memory as a favorite position.

In another embodiment of the present invention, the first arm and second arm are made of an aluminum alloy.

In another embodiment of the present invention, the mounting bracket further comprises a vertical pivot joint, thereby providing the mounting bracket with tilting capability.

In another embodiment of the present invention, the display system further comprises a bellows. This bellows extends from the enclosure to the mounting bracket, whereby the first arm and second arm are enclosed within the bellows, thereby protecting the first arm and second arm from dust.

### BRIEF DESCRIPTION OF THE DRAWINGS

FIG. 1A shows an exemplary embodiment of the display mounting system of the present invention in a retracted position.

FIG. 1B shows an exemplary embodiment of the display mounting system of the present invention in a retracted position with some covers removed to reveal internal parts.

FIG. 2 shows an exemplary embodiment of the display mounting system of the present invention in a fully extended position.

FIG. 3 shows the embodiment of FIG. 2 of the display mounting system of the present invention in an extended position, with the panels removed to reveal some internal parts.

FIG. 4 shows a top view of the embodiment of FIG. 2.

FIG. 4B shows an exemplary embodiment of the display mounting system of the present invention in a partially extended position.

FIG. 5 shows a side view of another embodiment of the display mounting system of the present invention that provides vertical angle adjustment.

FIG. 6 is a system block diagram of an embodiment of the display mounting system of the present invention.

FIG. 7 shows a top view of the display system 100 after final assembly.

### DETAILED DESCRIPTION

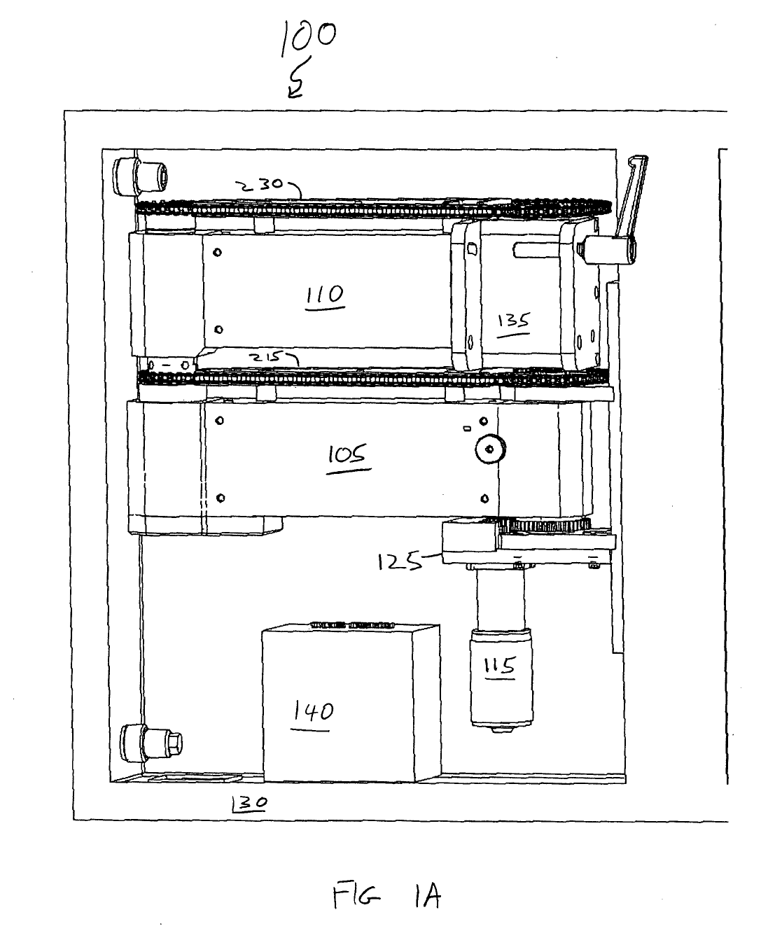

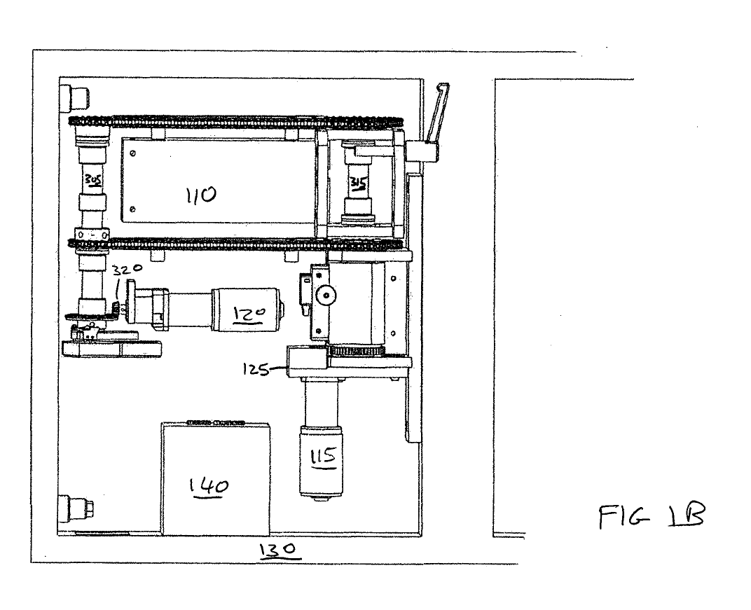

FIGS. 1A and 1B show the display mounting system 100 in a retracted position. The display mounting system 100 is comprised of lower arm 105, upper arm 110, extension motor 115, and pivot motor 120. Extension motor 115 is mounted to extension motor base 125. Extension motor base is mounted to enclosure 130. Enclosure 130 is mounted to studs (not shown) within the wall in which the display mounting system is installed. The enclosure 130 also contains a power supply 140 that supplies power to all electric and electronic devices within the display mounting system 100. In a preferred embodiment, the arms 105, 110 are made of a high-strength aluminum alloy.

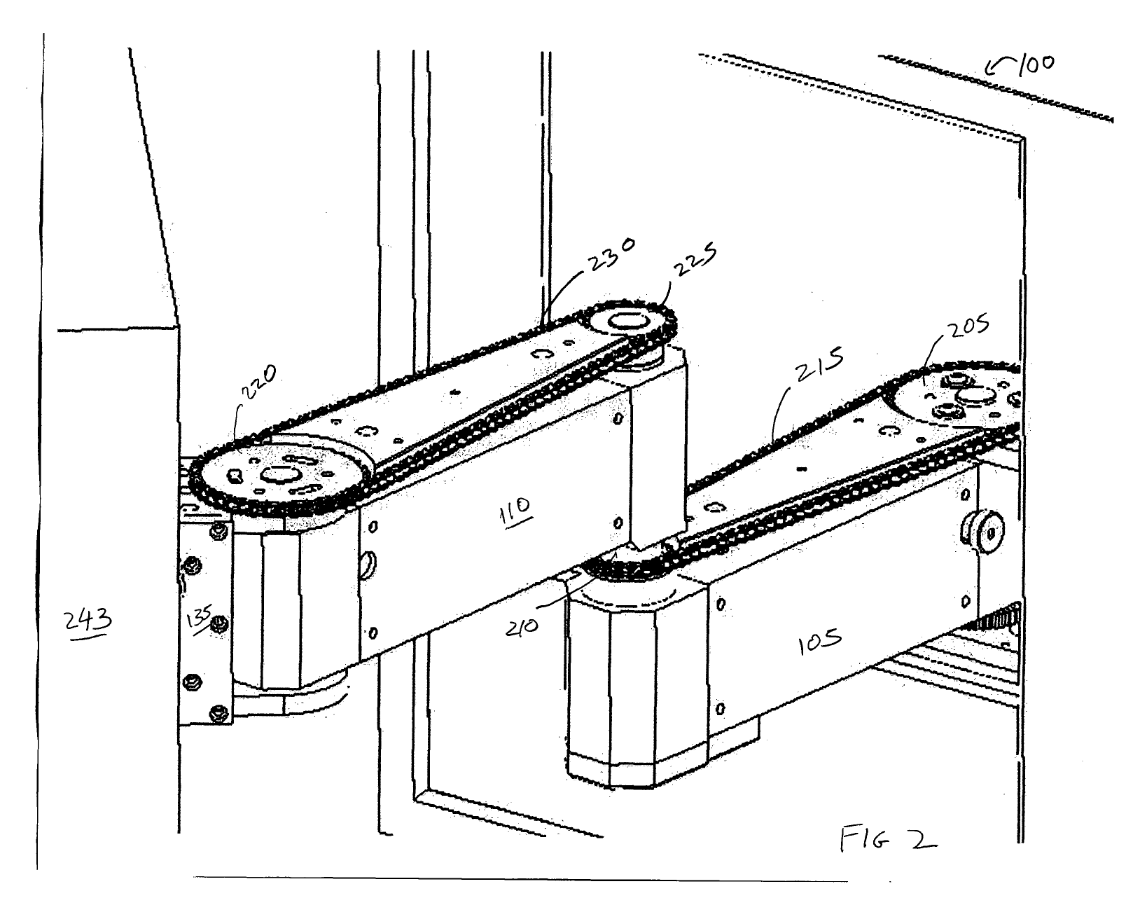

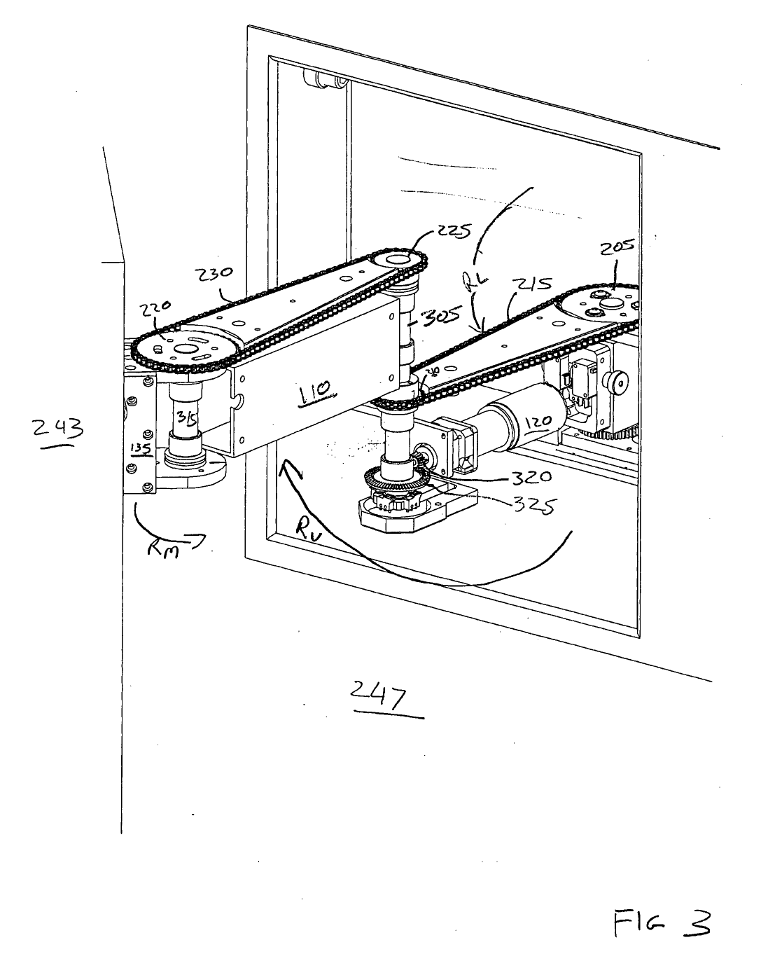

Referring now to FIGS. 2 and 3, the display mounting system 100 is shown in a fully extended position. Lower arm 105 has a large gear 205 driven by extension motor 115. At the opposite end of lower arm 105 is a small gear 210. Small gear 210 is driven by large gear 205 via drive chain 215. While chain 215 and gears 205, 210 are shown in this embodiment, a belt arrangement can be used instead, without departing from the scope of the present invention. Generically, a Upper arm 110 has small gear 225 that drives large gear 220 via drive chain 230. At the far end of upper arm 110 is monitor mounting bracket 135. When installation is complete, monitor mounting bracket 135 is mounted to display monitor 243.

FIG. 3 is similar to FIG. 2, but with covers removed to reveal internal parts. When the display mounting system 100 is moved from a retracted position to an extended position, extension motor 115 moves lower arm 105 out of enclosure 130. Lower arm large gear 205 is fixed, so as lower arm 105 moves along radius RL in the direction indicated by the arrow, small gear 210 is moving in a counterclockwise direction, as viewed in FIG. 3. Small gear 210 is attached to upper arm 110, hence upper arm extends along radius RU in the direction indicated by the arrow, simultaneously as the lower arm 105 is extending. As upper arm 110 moves along radius RU, upper arm small gear 225 is fixed with respect to upper arm 110. This causes upper arm large gear 220 to move in a counter clockwise direction, as viewed in FIG. 3. Upper arm large gear 220 is connected to mounting bracket 135. Therefore, as the upper arm 110 extends, mounting bracket 135 is moving along radius RM in the direction indicated by the arrow. Using this mechanism, then the ratio between the large gear and the small gear is chosen as 2 to 1, the motion will be such that mounting bracket 135 remains parallel to the wall during extension and retraction. Since mounting bracket 135 remains parallel to the wall during travel, the attached monitor 243 will also remain parallel to the wall during travel.

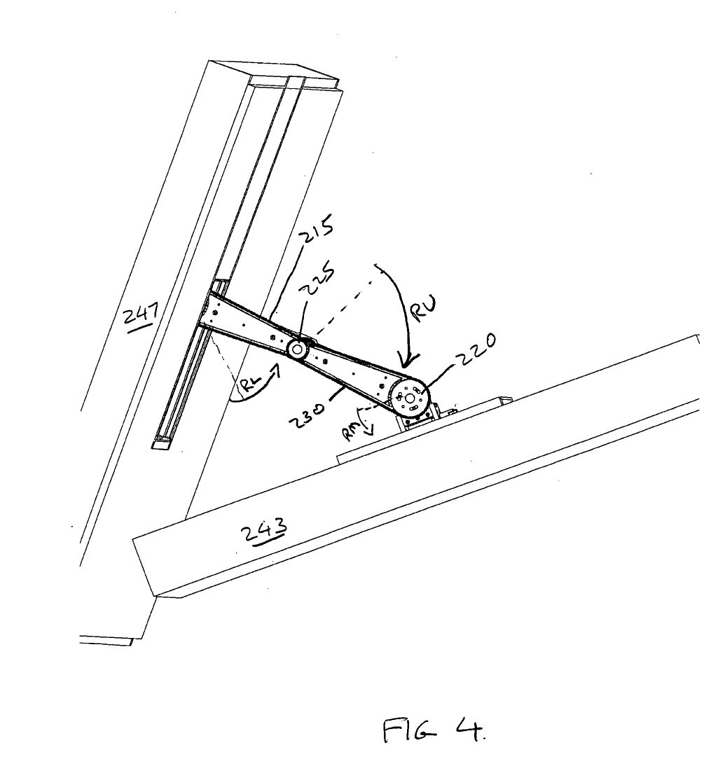

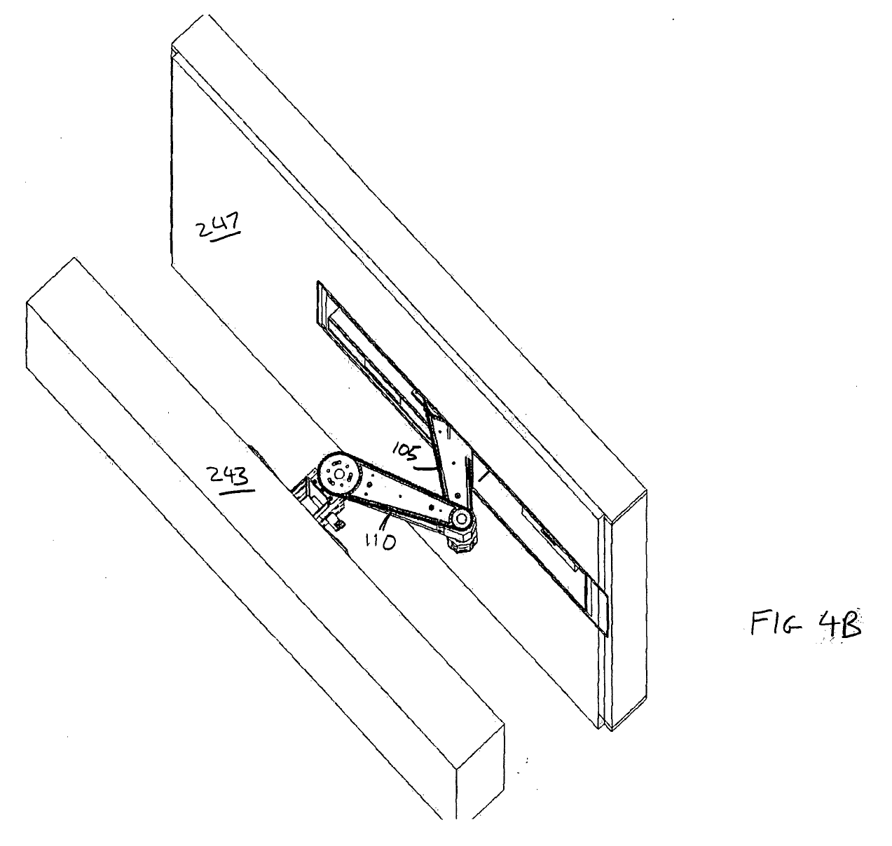

Once the mechanism has extended to the desired position, pivot motor 120 turns bevel gear pinion 320, which turns bevel gear 325. Bevel gear 325 is oriented perpendicularly to gear pinion 320, and is connected to shaft 305, which moves upper arm small gear 225. Upper arm small gear 225, via drive chain 230, moves upper arm large gear 220. Upper arm large gear 220 is connected to monitor mounting bracket 135. Therefore, by moving pivot motor 120 in the desired direction and amount, the viewing angle of display monitor 243 may be adjusted along radius RM. For the purposes of this disclosure, moving display monitor 243 along radius RM is referred to as “panning.” FIG. 4 shows a top view of display monitor 243 in a panned position. The pivot motor 120 provides panning control of the monitor bracket 135.

When retracting the display mounting system, the entire mechanism moves in reverse, again with the monitor mounting bracket 135 remaining parallel to wall 247 during travel.

FIG. 4B shows an exemplary embodiment of the display mounting system of the present invention in a partially extended position.

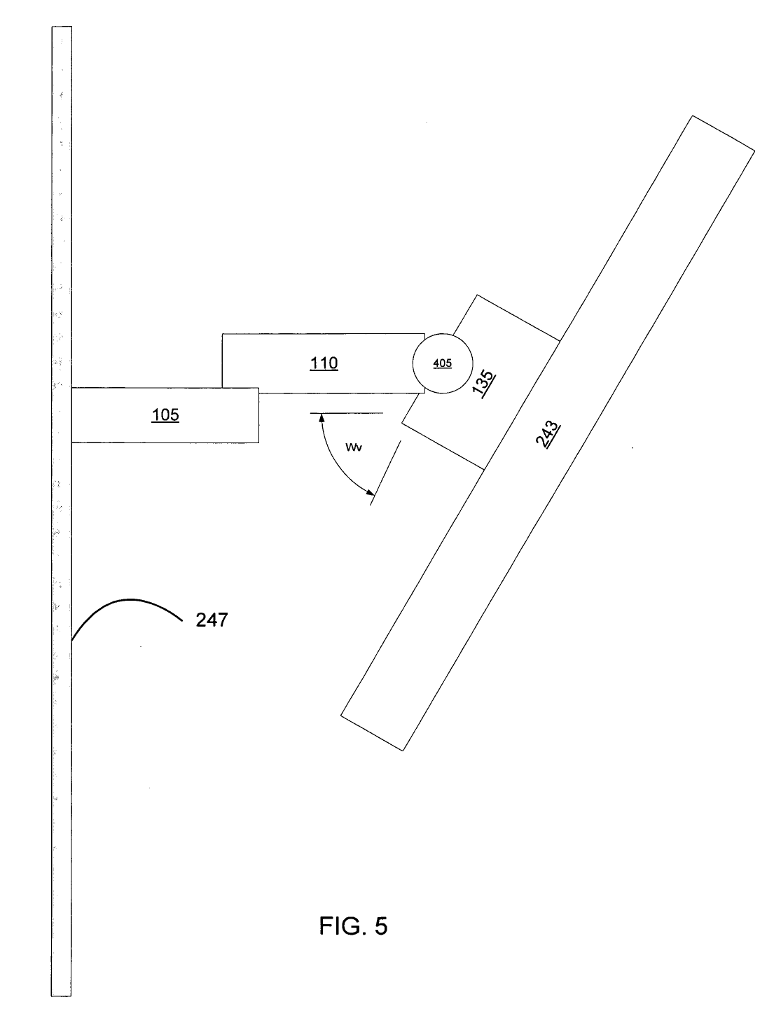

FIG. 5 shows another embodiment of the display mounting system that provides for vertical travel. In this case, the monitor mounting bracket 135 further comprises a vertical pivot joint 405 that allows monitor mounting bracket 135 to move downward to predetermined angle Wv. In an exemplary embodiment, upper arm 110 serves as a mechanical stop to limit the amount of travel of monitor mounting bracket 135, thereby setting the angle Wv. By adjusting the position of vertical joint 405 with respect to upper arm 110, a degree of adjustability of angle Wv can be achieved. This allows the display mounting system of the present invention to accommodate various mounting heights and viewing angles. For the purposes of this disclosure, moving display monitor 243 to create angle Wv is referred to as “tilting”.

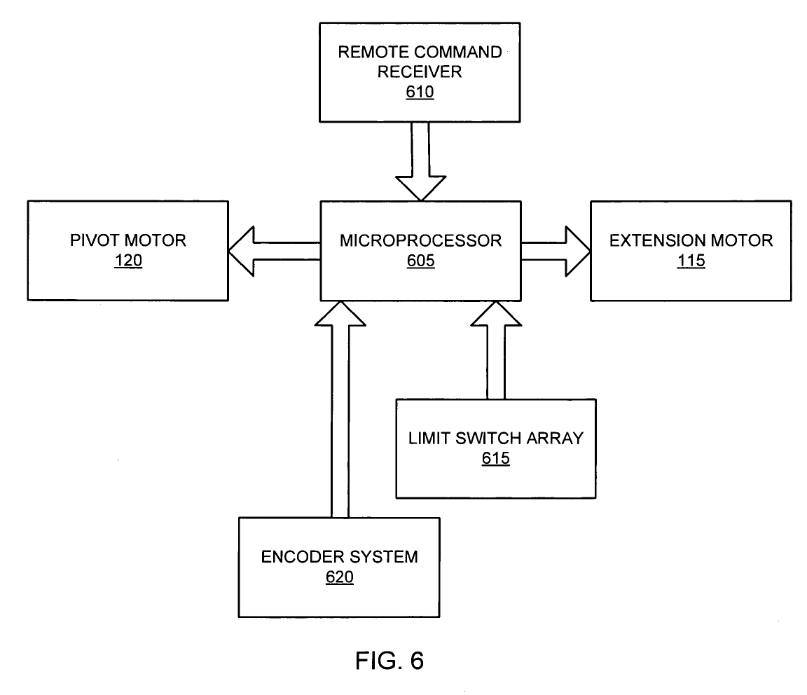

FIG. 6 shows a system block diagram of a preferred embodiment of the present invention. A microprocessor, located within enclosure 130, executes software instructions stored in memory (not shown), that controls operation of the display mounting system. Remote command receiver 610 relays user input commands from a remote control to microprocessor 605. Microprocessor 605 has memory (e.g. RAM and ROM) that is not shown, but is well understood by one skilled in the art of microprocessor systems. The remote command receiver may be an infrared (IR) receiver, a radio frequency receiver (RF), or any other suitable type of receiver that allows commands to be received. Limit switch array 615 and encoder system 620 provide position information to microcontroller 605 from a plurality of encoders and limit switches within the display mounting system. These limit switches (not shown) and encoders (not shown) provide feedback to microprocessor 605 about the position of the upper arm 110 and lower arm 105. The microprocessor issues control commands to extension motor 115 and pivot motor 120 to achieve the desired position as specified by the user via commands received via remote command receiver 610. The microprocessor may optionally store preferred positions in memory. When the user has moved the monitor to a preferred position, the user may press a button on the remote control (not shown). This button sends a command to microprocessor 605 to save the current position parameters to on board memory. In this way, a user can issue a command to return to a favorite position. For example, a button on the remote control would issue a “favorite” command to microprocessor 605. Microprocessor 605 then controls extension motor 115 and pivot motor 120 to place the display monitor 243 in the desired position. When the user is finished watching, and wants to return the monitor to the retracted position, a “home” button on the remote control (not shown), when pressed, results in a command being sent to microprocessor 605. This command will reset the panning angle, and retract the lower and upper arms 105, 110, thereby placing the monitor in its retracted position.

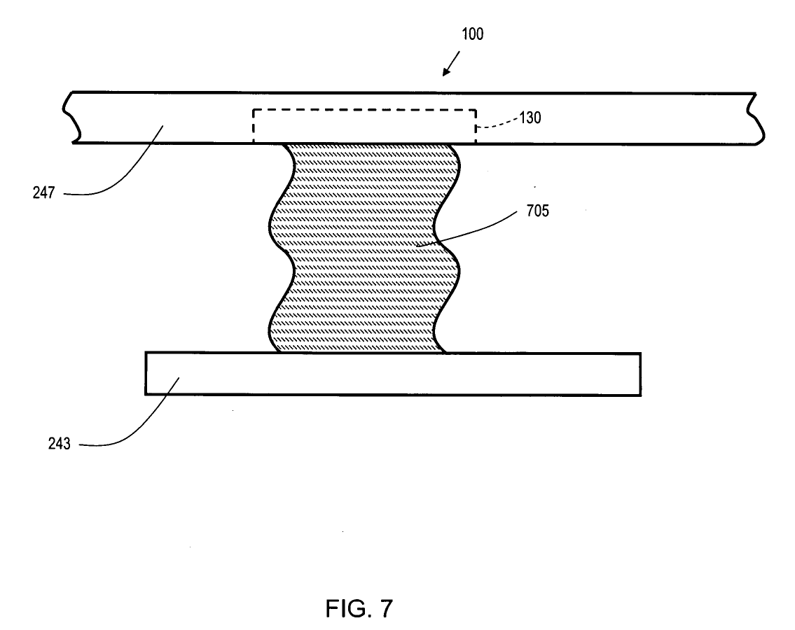

FIG. 7 shows a top view of the display system 100 after final assembly. As a final step, a bellows 705 connects between enclosure 130 mounted within wall 247, and the mounting bracket 135 (see FIG. 2) that holds display monitor 243. This serves to keep the mechanical assemblies free of dust, and also hides them from sight, thereby creating a more aesthetically pleasing appearance.

Accordingly, the reader will see that the invention provides an improved display mounting system that provides a convenient, safe, and decorative way to mount a flat panel display to a wall.

As can be seen from the preceding description, the present invention provides an improved display mounting system. It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

What is claimed is:

1. A display system comprising:
a first arm, having a first and second end, the first arm having a large gear at the first end and a small gear at the second end and a transmission means between the large gear of the first arm and the small gear of the first arm, with the first end rotatably mounted within an enclosure;
a second arm, having a first and second end, the second arm having a small gear at the first end and a large gear at the second end and a transmission means between the large gear of the second arm and the small gear of the second arm, wherein the small gear of the first arm is the same size as the small gear of the second arm, and the large gear of the first arm is the same size as the large gear of the second arm, and the first end of the second arm is rotatably connected to the second end of the first arm via a shaft, said shaft having the small gear of the first arm and the small gear of the second arm axially collocated thereon, wherein the second end of the second arm is rotatably connected to a mounting bracket;
motive means, said motive means mechanically connected to the small gears and large gears of the first and second arms via mechanical linkage; and
wherein the ratio of a large gear to a small gear is two to one, thereby maintaining the mounting bracket in an orientation parallel to the enclosure it is mounted to as it travels to and from the enclosure.

2. The display system of claim 1, wherein the transmission means between the large gear of the first arm and the small gear of the first arm is a chain, and the transmission means between the large gear of the second arm and the small gear of the second arm is a chain.

3. The display system of claim 1, wherein the transmission means between the large gear of the first arm and the small gear of the first arm is a belt, and the transmission means between the large gear of the second arm and the small gear of the second arm is a belt.

5. The display system of claim 1, wherein the motive means is an electric motor.

6. The display system of claim 1, further comprising a microprocessor, said microprocessor interfacing with a remote command receiver, said remote command receiver having receiving means for receiving remote control commands from a user, said microprocessor also controlling said motive means, thereby allowing the user to control the display system via a remote control.

7. The display system of claim 6, wherein said receiving means is an infrared receiver.

8. The display system of claim 6, wherein said receiving means is a radio frequency receiver.

9. The display system of claim 6, wherein the motive means further comprises a pivot motor, said pivot motor mechanically linked to small gear of said second arm via mechanical linkage, whereby the horizontal angle of the mounting bracket with respect to the enclosure is adjustable via said pivot motor.

10. The display system of claim 6, further comprising tracking means for tracking the current position of the first and second arms.

11. The display system of claim 10, wherein the tracking means is comprised of at least one encoder.

12. The display system of claim 10 wherein the current position of the first and second arms is stored in memory as a favorite position.

13. The display system of claim 10 wherein the position of the first and second arms is retrieved from memory as a favorite position.

14. The display system of claim 1, wherein the first arm and second arm are made of an aluminum alloy.

15. The display system of claim 1, wherein the mounting bracket further comprises a vertical pivot joint, thereby providing the mounting bracket with tilting capability.

16. The display system of claim 1, further comprising a bellows, said bellows extending from the enclosure to the mounting bracket, whereby the first arm and second arm are enclosed within the bellows, thereby protecting the first arm and second arm from dust.

17. The display system of claim 9, wherein the mechanical linkage comprises a gear pinion attached to the pivot motor, said gear pinion connected to a bevel gear oriented perpendicularly to the gear pinion, said bevel gear connected to a shaft, and said shaft connected to the small gear of the second arm, whereby panning control of the monitor bracket is provided.
